(19) United States
(12) Patent Application Publication
(10) Pub. No.: US 2015/0346936 A1
(43) Pub. Date: Dec. 3, 2015

(54) TOOLS AND METHODS FOR INTERACTIVE, PROFESSIONAL-LEVEL AT-HOME SKIN CARE

(71) Applicant: RODAN & FIELDS, LLC, San Francisco, CA (US)

(72) Inventors: Kathryn P. RODAN, San Francisco, CA (US); Kathy A. FIELDS, San Francisco, CA (US); Timothy J. FALLA, San Francisco, CA (US); Steven D. POWELL, Provo, UT (US)

(21) Appl. No.: 14/648,980

(22) PCT Filed: Dec. 2, 2013
(86) PCT No.: PCT/US13/72653

§ 371 Date: Jun. 2, 2015

Related U.S. Application Data
(60) Provisional application No. 61/732,391, filed on Dec. 2, 2012.
(60) Provisional application No. 61/762,824, filed on Feb. 8, 2013.

(51) Int. Cl. G06F 3/0484; G06F 17/30; H04L 29/08

(52) U.S. Cl. CPC G06F 3/0484; H04L 67/10; G06F 17/30864

(57) ABSTRACT

A method for providing professional-level skin care to consumers at home using an integrated system of one or more cosmetic skincare tools, skincare products and a mobile App, where the tool settings/frequency of use and a complementary skincare product regimen (product selection, frequency and order of use) are selected and changed based on user interaction with and data from the tool and/or App.

### PRIORITY CLAIM

This application is a U.S. national stage filing under 35 U.S.C. §371 of International Application No. PCT/US2013/072653 filed Dec. 2, 2013 entitled “TOOLS AND METHODS FOR INTERACTIVE, PROFESSIONAL-LEVEL AT-HOME SKIN CARE,” which priority is claimed to U.S. Provisional Patent Application Ser. No. 61/732,391 filed on Dec. 2, 2012 and U.S. Provisional Patent Application Ser. No. 61/762,824 filed on Feb. 8, 2013, the disclosures of which are incorporated by reference in their entireties.

### FIELD OF INVENTION

The present invention relates to a method for providing at-home skincare solutions to consumers using an integrated system of one or more cosmetic skincare tools, skincare products and a mobile App, where the tool settings/frequency of use and a complementary skincare product regimen (product selection, frequency and order of use) are selected and changed based on user interaction with and data from the tool and/or App.

### BACKGROUND OF INVENTION

Despite the widespread availability of a plethora of topical skincare products, increasingly sophisticated consumers want more. With a demographic cohort spanning Gen Xers and Millenials who have made healthy appearance a priority, there is an unmet demand for the same types of results as treatments offered by dermatologists (and other licensed skincare professionals) but in less time and without time-consuming visits to the doctors' office or medispa. The availability of these treatments is limited not only by consumer resources—time and financial—but also by regulation. Many of the implements used in professional skincare are regulated by FDA as medical devices and are therefore not available to consuming public for use at home.

Medical devices include instruments, implements and machines that are intended for use in the cure, mitigation, treatment, or prevention of disease, or are intended to affect the structure or any function of the human body but which do not achieve any of the primary intended purposes through chemical action in or on the body. Some new medical devices require a rigorous review before being approved for use. Others can be marketed without FDA premarket notification if the device is shown to be “substantially equivalent” to a device that is already legally marketed for the same use. Still other devices are considered to be “510(k) exempt”, meaning that a premarket notification application and FDA clearance is not required before marketing the device in the United States.

Dermabrasion is a process designed to remove a controlled thickness of damaged skin to stimulate normal wound healing and skin rejuvenation while avoiding the complications of scarring and pigmentary changes. See, e.g., Kim E K, Hovsepian R V, Mathew P, Paul M D. Dermabrasion. Clin. Plast. Surg. July 2011; 38(3):391-5, v-vi. After years of clinical experience, FDA determined that these dermabrasion devices are safe and effective for specific indications: general dermabrasion, scar revision, acne scar revision, and tattoo removal.

There are two general types of dermabrasion devices—manual and motorized—regulated under 21 CFR §878.4800 and 21 CFR 878.4820, respectively. The latter regulation is applicable to surgical instrument motors and accessories intended for use during surgical procedures to provide power to operate various accessories or attachments that cut soft tissue, including dermabrasion brushes and dermatomes.

As long as a dermabrasion device is similar to those that are already legally on the market, a premarket notification (510(k)) is not necessary. However, a 510(k) would be required for a dermabrasion device that would be marketed for an indication different than those listed in the preceding paragraph, namely a device that contains output parameters (pressure, rotations per minute) which are intended for indications different from those of legally-marketed devices, operates via a different mode of action, or uses a different abrasion substrate. In contrast, cosmetic exfoliation tools and accessories that remove only the uppermost dead layers of skin cells are not medical devices.

There has long been a need for achieving skincare results similar to those achieved by a dermatologist but without a dermabrasion device. At the time of the instant invention, products available to consumers did not meet this need. By providing an interactive cosmetic tool and dynamic method of using that tool in combination with specific skincare products, the present invention meets a long felt, but as yet unmet need. As discussed in greater detail below, the ability of the present invention to provide consumers with professional-level skin care results at home requires a tool that interactively provides user feedback and allows modification of treatment parameters based on clinician in-office experience.

In medical practice, poor patient compliance can be a major contributing factor to the lack of efficacy of a treatment. In consumer skincare, a similar problem is encountered. Because improvement in skin appearance can take weeks, if not months, before becoming visible, consumers often become frustrated and do not follow a recommended regimen. By providing more immediate, and in certain embodiments, nearly instantaneous, feedback to the consumer that steps have been taken that will result in improvements, the present invention provides a solution to this problem.

Sections of the human face, neck and décolleté are of different epidermal thickness and sensitivity. Excessive exfoliation—duration, intensity or both—can have clinically undesirable outcomes, including irritation. A need thus remains for a cosmetic tool that provides an appropriate amount of exfoliation without undesired clinical effects. This need is also met by the methods of the present invention.

### SUMMARY OF THE INVENTION

Disclosed are methods of improving the appearance of at least one skin parameter by employing an at-home skincare system, comprising the steps of (a) providing a user in need of improving the appearance of one or more skin parameters with an electromechanical cosmetic skincare tool, the tool having a unique identifier and preferably having wireless connectivity, (b) the user downloading a mobile App, a software application designed to run on smartphone, a tablet computer, or other mobile telecommunication device, (c) querying the user and inputting information identifying the user and her/his skin condition, preferably via the App, and the user's cosmetic skincare tool, (d) transmitting and receiving data about use of the cosmetic skincare tool, preferably via the App and/or via the tool itself, (e) recommending changes to the user's skincare regimen and/or the manner in which the user's cosmetic skincare tool.

The methods of the present invention can, and preferred embodiments do, involve one or more further steps wherein (a) the user (i) creates a photographic progress archive in the App (ii) enters her/his self-assessment of changes in her/his skin appearance before and after using the cosmetic skincare tool, and/or (iii) transmits information about or collected/recorded during or after one or more sessions in which the cosmetic skincare tool has been used, and (b) based on (i), (ii) and/or (iii), the user receives recommendations for changes to the user's skincare regimen and/or use of the cosmetic skincare tool, such recommendations preferably being provided to the user via the App.

### DETAILED DESCRIPTION OF THE INVENTION

A core element of the present invention is establishing and programming operating parameters for a cosmetic tool based on the clinical experience of trained, licensed skincare professionals, preferably dermatologists, using an FDA-regulated medical device, preferably a Class I device, to perform a professional procedure, here dermabrasion. This type of programming is referred to as DocSmart. Preferably the cosmetic tool has wireless connectivity enabling it to communicate with (i.e., receive and transmit data and messages to and from) a software application (also referred to herein as an “App”), preferably designed to run on smartphones, tablet computers or other mobile telecommunication devices.

### Macro-Exfoliation Tool (Macro-E)

One example of an at-home skin care appliance that may be used in accordance with the methods of the present invention is a cosmetic macro-exfoliation tool. As used in the present application, by the term macro-exfoliation is meant loosening, detachment and removal of the outermost dead layers of skin on the human body.

The cosmetic macro-exfoliation tool, referred to herein as Macro-E, and further described below, is comprised of (i) a removable exfoliation tip unit, comprised of an abrasive head, a gasket and a filter) (ii) a vacuum pump, (iii) a motor, (iv) a microcontroller (MCU) containing a processor core, memory (e.g., flash, ROM and/or RAM) and programmable input/output peripherals, (v) a user control panel comprising a plurality buttons and/or switches, (vi) a battery and battery charger and (vi) a display panel (indicating body section to be exfoliated, and, optionally, and preferably, level and duration of macro-exfoliation (expressed as total time and/or time remaining in) and remaining battery charge.

The settings on Macro-E tool are, in a preferred embodiment, pre-programmed (referred to herein as “DocSmart” mode, and described in detail below), but can be adjusted by the user via a control panel that sends signals to a MCU. The motor, which receives power from a battery, is also regulated by the MCU. The motor drives the pump which produces a suction (pressure) through a top housing compartment, preferably cylindrical, that is configured to receive a removable exfoliation tip. In one embodiment, the abrasive head is a diamond tip, preferably 100#.

The bottom of the removable exfoliation tip unit is a filter, preferably a non-removable stainless steel screen, that functions to stop/trap dead exfoliated skin cells (and other debris) removed from the user's skin by the Macro-E tool. The filter is seated, preferably permanently affixed, inside the bottom of a bucket, which is preferably attached to a diamond head by threads located on both the bucket and diamond head. In a preferred embodiment, a rubber gasket fixed around the bucket is pressed between the diamond head and bucket when screwed together. The diameter of the rubber gasket is slightly larger than that of the diamond head so as to minimize air leakage when the exfoliation tip unit is inserted into the top housing compartment.

The vacuum creates a seal between the abrasive tip and the skin surface to be macro-exfoliated, thereby keeping the tip perpendicular to, and maximizing contact time with, the surface, and also serves to remove dead skin that has been loosened by passage of the abrasive tip over the skin surface.

Optionally, in certain embodiments, the Macro-E has a wireless connectivity component (or module) that may be a Bluetooth system, a ZigBee system, a Certified Wireless USB system, a Near Field Communication (NFC) system, an Active RFID system, a Wi-Fi system, and combinations thereof.

Sections of the human face, neck and décolleté not only have different epidermal thickness but also different levels of sensitivity to mechanical forces. For example, the skin in the area immediately surrounding the eyes is thinner than the skin on the forehead. Accordingly, the forehead can comfortably and safely tolerate more exfoliation than the eye area. Taking into account differing thickness and sensitivity of regions of the body, the Macro-E tool is programmed with DocSmart, a series of operating parameters based on the clinical experience and judgment of trained skin care professionals to achieve results similar to those achieved in a professional setting (doctor's office, medispa, or similar environment in which an aesthetician performs skin and body care treatments, e.g., facials, dermabrasion, acid skin peels).

In a preferred embodiment, DocSmart provides Macro-E with separate exfoliation settings for each of the following body sections—forehead, the under-eye areas, the cheeks, the nose, the chin, the neck and the chest.

In a more preferred embodiment, Macro-E has a display panel that indicates the body section being treated. In this embodiment, the display preferably has a timer that counts down the pre-programmed time and, in a more preferred embodiment, momentarily pauses and emits and audible signal (e.g., beep two times), communicating to the user to position the tool on the next area of the body to be macro-exfoliated.

In a still more preferred embodiment, the display panel indicates the direction in which the user should orient the stroke of the Macro-E. On the cheeks, Macro-E is stroked down and around the mouth following the shape of the face. The nose is stroked from the midpoint down and out on each side. Above the lips, Macro-E is stroked down vertically. The chin is also stroked in downward vertical direction. The forehead is exfoliated by passing the Macro-E in a horizontal direction from the midpoint outwards on each side. Under the eyes, a horizontal stroke is used away from the nose and from the outer corners outwards towards ears on each side. The neck is stroked vertically downward. A horizontal motion is used on the chest from the midpoint outwards on each side.

The Macro-E tool, which is further described below with reference to the attached drawings, may be programmed to macro-exfoliate (also referred to below as “exfoliation”) different sections of the body with differing levels of pressure. By way of non-limiting example, in one embodiment the Macro-E is programmed with ten exfoliation levels, designated 1-10, where level 1 is the lowest setting, while level 10 provides the most exfoliation. In this embodiment, level 10 provides a negative suction pressure of about 31-32 kPa, and level 1 provides a negative suction pressure of about 20-21 kPa. Each descending level has an average decrease of about 1 kPa. For example, Level 9 is about 30-31 kPa and Level 8 is about 29-30 kPa.

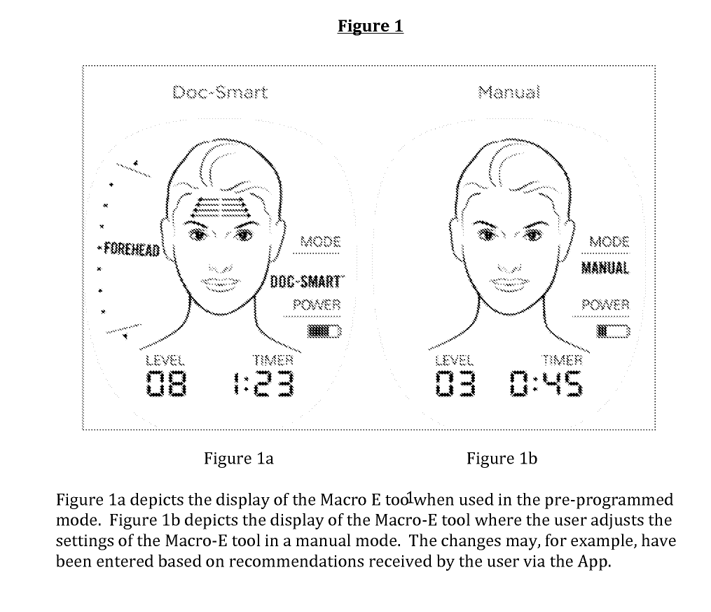

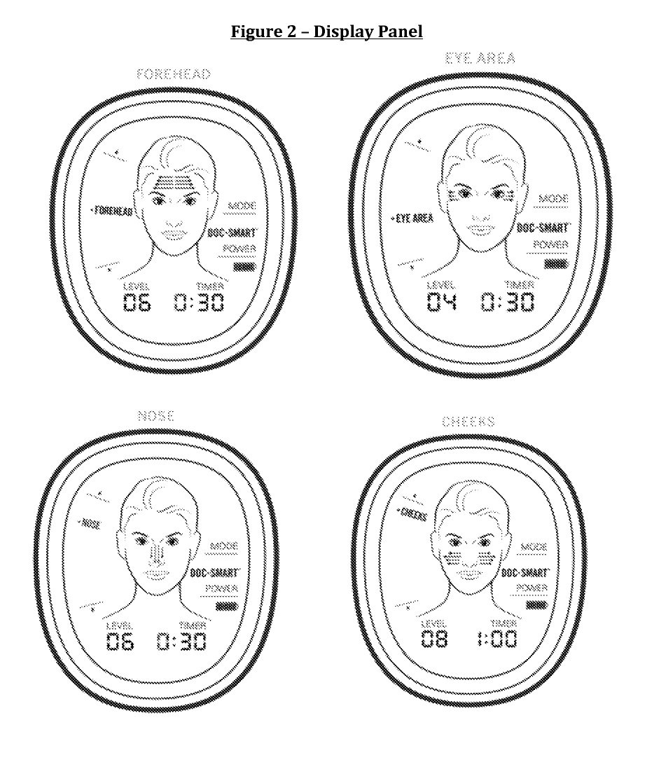

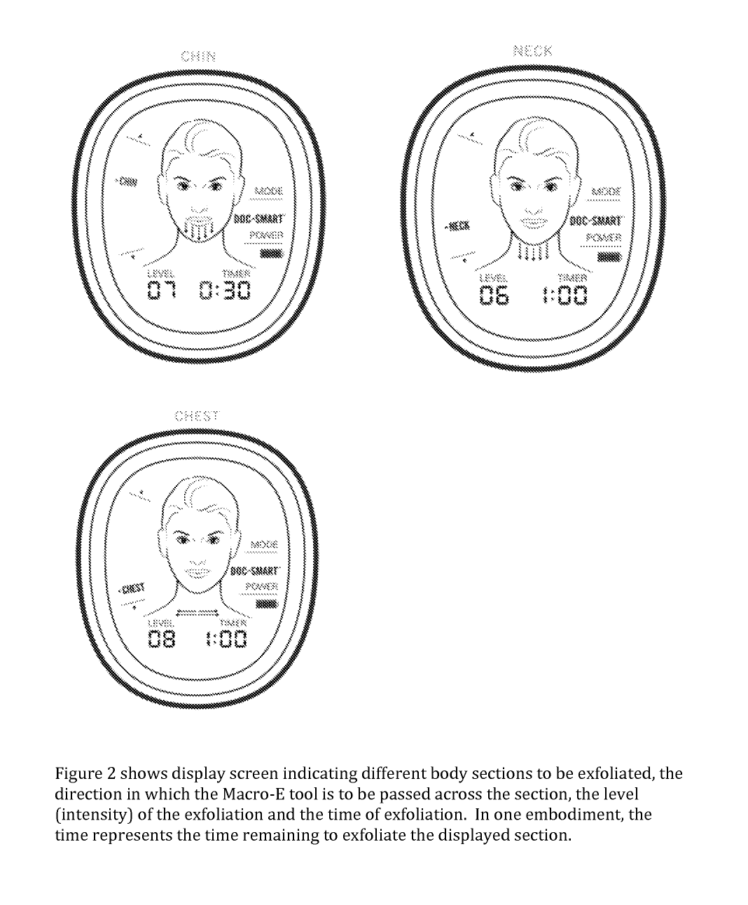

The following table provides a non-limiting example illustrating different exfoliation levels (contact time and pressure) for different body parts and is shown in FIG. 2:

| Facial Area | Duration of Program | | Level |
|---|---|---|---|
| Cheeks | 1:00 | minute | 8 |
| Nose | 30 | seconds | 6 |
| Chin | 30 | seconds | 7 |
| Forehead | 30 | seconds | 6 |
| Eye Area | 30 | seconds | 4 |
| Neck | 1:00 | minute | 6 |
| Chest | 1:00 | minute | 8 |

### DocSmart

A second key element of the present invention is integration of the Macro-E tool with application software, commonly known by the short-hand App, preferably an App for a software application designed to run on smartphones, tablet computers or other mobile telecommunication device. In a particularly preferred embodiment, the App is a mobile App that is in wireless communication with the Macro-E tool, for example via Bluetooth. The App allows the user to transmit and receive information about her/his progress and, as discussed in detail below, improves the results achieved with the Macro-E. In the present application, the Macro-E App provides a means whereby improvements in the appearance of the user's skin can be tracked and recommendations can be made to enhance, accelerate or maintain those improvements, including changes to the Macro-E settings or skincare products used in conjunction with the Macro-E tool, both based on criteria set by skin care professionals, preferably dermatologists.

In one embodiment, the user connects to the internet, preferably on her/his mobile telecommunications device or desktop computer, downloads the App, enters her/his name and register the Macro-E tool, which is packaged with and/or labeled with a unique product identifier.

In a preferred embodiment, the user name entered when registering the Macro-E tool is compared with, and matched to a record in a database of skincare product users. In this preferred embodiment, additional information about the user in the database, including one or more of address, age, gender, residence location, product(s) used, skin condition(s) and skin care concerns, and optionally, and in preferred embodiments, occupation, and at least one, preferably at least two, and still more preferably at least three lifestyle factors selected from (i) smoking history (e.g., never, previously but not currently, infrequently, regularly), (ii) hours spent outdoors, (iii) frequency of use of sunscreen and/or sunglasses, (iv) sleep preferences (side, back, stomach), (v) average number of hours of sleep per night, and/or (vi) frequency of use of straw when consuming a beverage) is known and associated with the Macro-E tool.

Alternatively, if a record corresponding to the user who registers the Macro-E tool is not in the skincare product user database, a user is asked to complete a profile providing the above information, thereby creating a unique user profile record. Information comprising the unique user profile record can also be input by a third party on behalf of a user, including by a skincare consultant or call center.

Interactively providing messages or requiring user actions, including via notifications and reminders, improves user compliance in several ways.

One aspect of the method of the present invention is directed at improving user compliance through the step of providing messages when the Macro-E tool should be used—preferably, the message is provided at least once per week, still more preferably the message is provided on the day the user should perform one or more steps with the cosmetic tool and/or perform one or more steps in a skincare regimen, still more preferably the message is provided at a specific time or timeframe (e.g., morning, evening) on the day when the user should undertake the specified step(s).

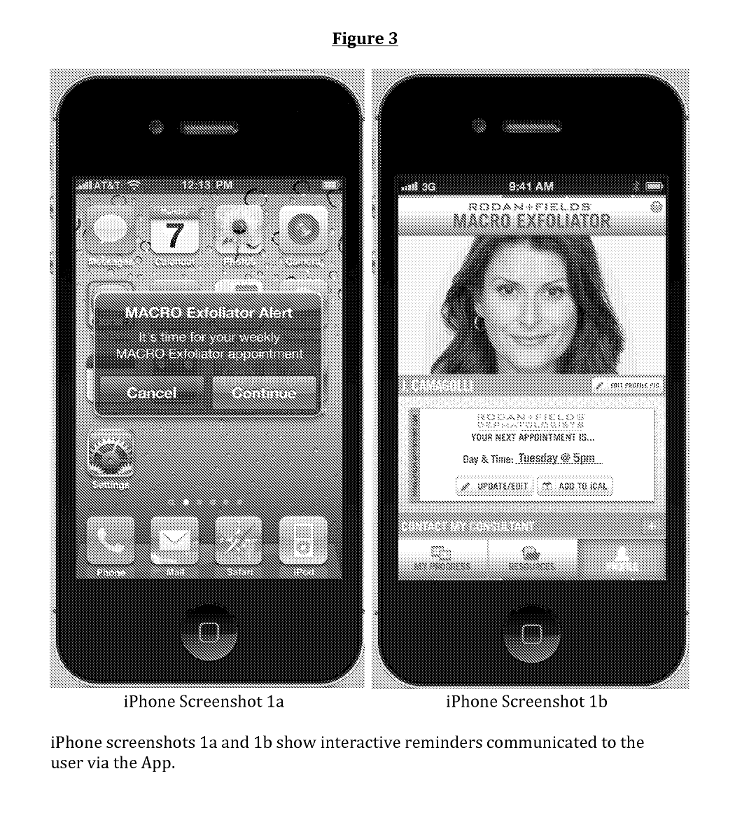

In one preferred aspect of the present invention, the App is downloaded to the user's mobile telecommunications device. The App provides one or more reminders corresponding to the time(s) the Macro-E tool should be used. In the attached figures, the reminder is referred to as a “weekly appointment”. See FIG. 3.

Preferably, the reminder(s) are displayed on the user's mobile telecommunications device as a notification, badge or alert. Additionally, the reminder(s) may be sent to the user via a second electronic message format—SMS sent to the user's mobile telecommunications device and/or email(s) to one or more e-mail address(es) provided by the user.

In a second aspect directed toward improved user compliance, the App reminds/requests that the user send a reply indicating that the Macro-E tool has been used as directed. Such “used as instructed” reminder requests continue until the user sends a reply indicating completion (compliance) with the prescribed instructions. In embodiments of the present invention in which the Macro-E tool has a means for wireless communication with the App, the “used as instructed” reply step is automated. For example, the Macro-E tool sends a signal via Bluetooth that is received by the App indicating when the tool has been used.

User compliance is also improved through yet another feature of the App that allows the user to join a social network community hosted on a website via the App. By joining a community, the user can elect to share her/his comments about her/his progress, including before and after photographs. Other users can view the progress and, in a preferred embodiment, post messages on an online bullet board, commenting on the progress as shown in the shared (i.e., posted) before and after photographs.

In response to the user reply, optionally, but preferably, the App transmits a message reminding the user to take one or more additional actions.

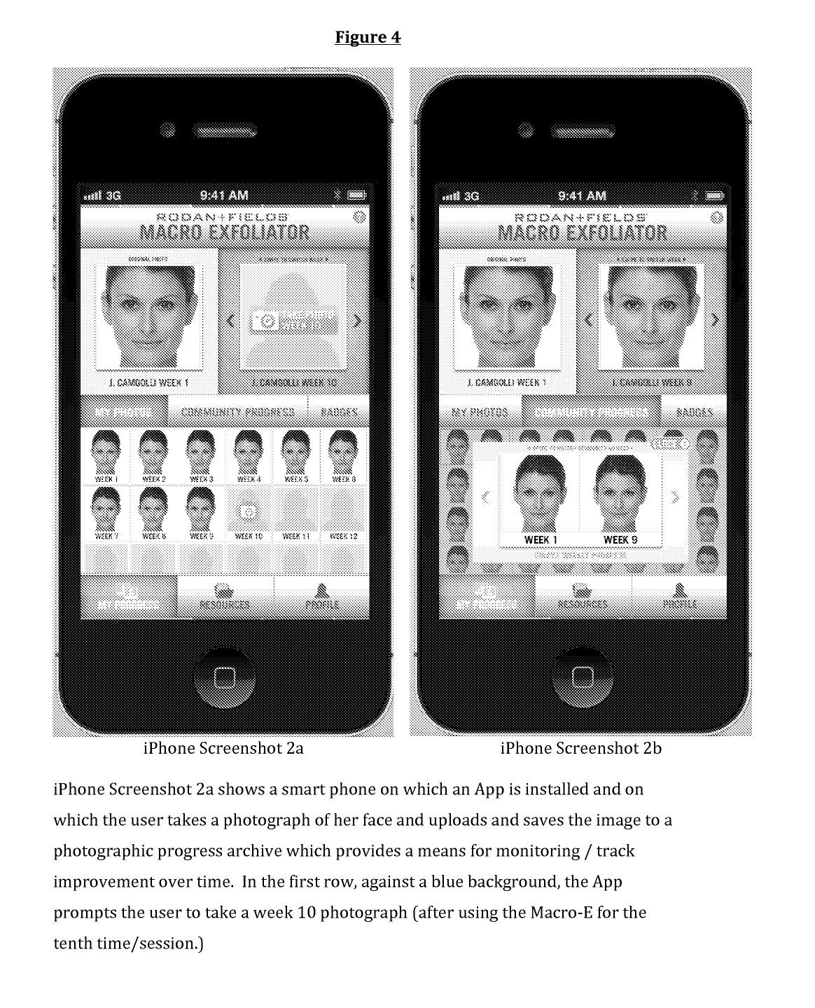

In one example, the App reminds the user to take a photograph, preferably weekly and upload or save that photograph to a digital archive that can be used to monitor the user's progress. See FIG. 4. This interactive digital archive feature of the App is illustrated in FIG. 4 entitled iPhone Screenshots 2a and 2b. Creating an historical image record not only allows the user to track her/his own progress, it also allows changes from baseline to be analyzed and reported to the User, via the App, using image analysis computer software.

Image analysis software is commercially available and can compare changes in one or more of (i) number and/or depth of fine lines and wrinkles and (ii) reduction in the darkness of sports and or areas of hyper-pigmentation, and/or (iii) evenness of skin tone. The image analysis software can be part of the App software itself, or can be stored and run on a different computer that communicates with the App.

In addition to uploading photographs and/or data collected from the Macro-E tool (e.g., number, volume, or weight of exfoliated skin particles generated in a particular session, see discussion below), the App can, and preferably does query the user after each scheduled session (i.e., “appointment”) to subjectively assess changes in her/his skin appearance based on at least one, preferably two, still more preferably three, and most preferably all four of (i) radiance, (ii) dark marks, (iii) lines/wrinkles, and/or (iv) firmness. An example of user interaction and response to a query about changes with use of the Macro-E tool is provided in iPhone Screenshot 3. See FIG. 5. Providing the user with a well-documented archival record of changes in her/his appearance, and prompting the user to conduct self-assessment, and then to be able to affirmatively identify an improvement in one or more of the above criteria provides further confirmation of progress/improvement. This reinforcement encourages the user to continue Macro-E sessions, thereby achieving further improvements and, after achieving a desired endpoints (reduced appearance in fine lines/wrinkles, reduced appearance of pores, more even skin tone, increased skin firmness), maintaining the desired endpoints by continuing a recommended skincare regimen (e.g., use of the Macro-E and complementary topical products for the user's specific skin condition(s)).

Additionally, based on the photographs and self-reported improvements, the user may, and in preferred embodiments does, receive notifications about further improvements that should be expected based on changes already noted. These anticipated improvements provide further impetus for the user to continue to use the Macro-E tool and associated regimen of skincare products.

Compliance is further improved by providing the user with one or more forms of feedback. As discussed in the immediately preceding paragraphs, feedback can be in the form of visual improvement as seen in photographs that have been stored in the user's digital archive and user self-assessment. Feedback can also be in the form computer image analysis. Additionally, as discussed below, in certain embodiments, the Macro-E tool provides feedback based on the macro-exfoliation data itself.

In one aspect of the present invention, feedback indicative of improvement of one or more skin condition parameters is provided to the user via a display panel on the Macro-E tool or via the App that receives information (data) from the Macro-E tool. In one embodiment of this aspect of the invention, the tip assembly of the Macro-E tool is configured with one or more optical counting units that monitor/measure and analyze dead exfoliated skin particles passing into the tip. Hand held air sampling apparatus capable of detecting and differentiating between particles based on size and density are known in the art, as are techniques for dynamically measuring the concentration and size distribution of particles which, as discussed below, include light scattering.

The tip may be configured with one, or preferably a plurality of, optical particle characterization (OPC) unit(s), each comprising a signal processor communicatively coupled to an optical sensor having a light source that provides incident light to a first lens, where in a preferred embodiment, the light is collimated and the passes through a light scattering zone. In a preferred embodiment, the light scattering zone is a plurality of intersecting light beams, preferably forming a grid, generated by the OPC units. Dead skin particles dislodged, loosened and detached from the outermost layer of the stratum corneum are drawn through the opening in the tip during use of the Macro-E tool pass through this zone, scattering the light. The light then passes through a second lens, and is recorded by an optical sensor that converts the recorded light into voltage. The sensor transmits an output signal to a signal processor that is proportional to the voltage. Based on the amount of scattering (light fluctuation) the signal processor quantifies (counts) and in preferred embodiments differentiates and characterizes particles within the light scattering zone and stores and/or transmits information about the particles to an output interface, for example, the LCD display screen. In embodiments wherein the signal processor or communicatively connected software performs a differentiation step, dead skin particles are distinguished from other debris on the skin surface. Still more preferably, the information generated by the signal processor includes number of particles and, in a preferred embodiment, particle density.

The particle information generated by the signal processor may also be transferred for processing and/or display to a separate computing device or mobile communications device (e.g., smart phone) through an output interface. In one embodiment of the invention, the interface is a conventional data port into which a cable can be plugged for connection to an external device. In other embodiments the interface can be a data logger or a wireless communication system.

The amount and difference in exfoliated dead skin cells provides feedback to the user in several ways. For example, a large number of exfoliated dead skin cells would cause more interruption of more light beams and would thereby reduce the recorded light, and corresponding voltage. This would indicate that the outermost layers of skin are lax (not tight) and also that the skin barrier, which serves to retain moisture, is impaired. With each subsequent session with the Macro-E tool, less skin particles would be exfoliated, more light would pass unimpeded (without scattering), yielding a higher amount of recorded light. This would indicate to the user that the outermost layers of skin are becoming tighter and also that skin barrier function is improving. As discussed below, increased skin moisture content (e.g., over baseline and earlier periods of Macro-E tool use) could be measured directly via a separate probe attached to the Macro-E.

In another embodiment of this aspect of the present invention, the tip assembly is weighed before and after the macro-exfoliation session (passing the Macro-E device over each of the desired sections of the body). The more exfoliated skin that is measured, the more the user is signaled that her/his skin is not tight and is losing moisture. Conversely, with increased use, the before/after differential in tip weight should decrease, conveying to the user an improvement in skin tightness.

In a further embodiment, the Macro-E tip is configured with a multi-stage (i.e., multi-level) gravimetric sizing assembly (MGS). The MGS assembly is configured with more than one filter, each of differing pore sizes. Filters having larger pore sizes are positioned closest to the tip opening. Additional filters having progressively smaller pore sizes are added to create a sieve. The filters are then removed and weighed. Subtracting the weight of the filter prior to macro-exfoliation, provides data representative of the amount (weight) of exfoliated skin. As discussed above, a large weight differential is indicative of lax skin that does not efficiently retain moisture.

In one embodiment, the user may be provided with a balance for weighing the tip or filters. The user would then report the weight differential via the App. In a further embodiment the balance may be integrated into a recharging base stand for the Macro-E tool.

In an alternative embodiment, a sensor is positioned beneath the tip, and detects, records and/or stores the weight changes before and after macro-exfoliation. The weight differential may be communicated to the display panel and, in embodiments of the Macro-E tool having wireless connectivity, via the App.

In another embodiment of this aspect of the invention, the tip is configured with an MGS assembly having at least two filters, and a plurality of OPC units, each forming a grid of intersecting light beams, wherein a first light scattering grid is positioned below the tip opening and above a first filter, and a second light scattering grid is positioned below the first filter and above a second filter. This embodiment provides a means for further differentiating and characterizing skin particles and presenting particle size information corresponding to the quality of skin that has been exfoliated. Tighter skin, having improved barrier function, would be smaller in size and higher in density compared to more lax skin, having impaired barrier function. Improvement in skin moisture retention and tightness would be indicated by a higher amount of recorded light in the first light scattering zone, and a lower recorded light in the second light scattering zone. This result would be understood to indicate the smaller, denser skin particles, were passing through the first filter. Flaky, less dense exfoliated skin particles, characteristic of dry and/or lax skin would be sufficiently large so as not to pass through the first stage filter.

Optionally, the Macro-E may be equipped with one or more probes that measure one or more of skin moisture content, skin density (via ultrasonography).

In embodiments of the present invention in which the Macro-E tool has a means for wireless communication with the App, compliance is further improved by transmission of data relating to the Macro-E session—date, time, duration of use of the Macro-E tool, whether DocSmart mode or different level(s) of macro-exfoliation were selected.

By way of non-limiting example, if the user of the Macro-E tool experiences discomfort when initially using the tool, the user is instructed to “dial down” or decrease the intensity of the pre-programmed (DocSmart) levels of exfoliation. By transmitting this information (lower intensity) via the App, the user could receive one or more of recommendations to change Macro-E settings, maintain exfoliation levels but decrease time of use for a specified period of time, change complementary skin care products recommended for the user's skin condition(s), or a combination of the foregoing. The user would then receive messages via the App querying whether the recommended changes were comfortable and, after a period of acclimatization, the user would receive further messages recommending changes—for example, resumption of DocSmart settings.

The efficacy of at-home skin care is improved by the present invention in ways heretofore not possible—namely, allowing users of the Macro-E tool to achieve professional level skin care results at home—by one or both of (i) improving one or more skin attributes selected from (a) increased radiance, (b) decreased appearance of dark marks, (c) reduced appearance of fine lines and wrinkles, (d) increased skin firmness or elasticity and/or (e) increased skin moisture content and/or (ii) decreasing the time before the improvement(s) can be recognized (e.g., by self-assessment) or measured (e.g., by image analysis or instrumentation). This advance is achieved via interactivity with an App, preferably a mobile App, and, in embodiments in which the App is in communication with the Macro-E tool (e.g., via Bluetooth), with the Macro-E tool itself.

In a first embodiment of this aspect of the invention, recommendations for changing the Macro-E settings and/or the skin care products being used in combination with the Macro-E sessions are sent to the App. In this embodiment, the user implements the suggested changes to the Macro-E by changing one or more Macro-E settings via the user control panel. To further ensure user compliance, reminders are sent to the user's mobile telecommunications device via the App as described above. In a preferred embodiment, the reminders continue to be sent to the App (and displayed as a notification, badge or alert), or via an alternative electronic message format (email or SMS) designated by the user, at regular intervals (e.g., once daily) until the user replies via the App to indicate that the new settings have been received, input and saved in the Macro-E.

In a second embodiment, in which the Macro-E has wireless connectivity, and, for example, the App is in wireless communication with the Macro-E tool, the changes in Macro-E settings are transmitted to, and stored in, the App and thereafter transmitted to and stored in the MCU on the Macro-E tool. By way of non-limiting example, the user of an iPhone may receive a notification that an update to the App is available. The user would download and install the update that would contain the new settings for the Macro-E tool. Alternatively, the changes are directly transmitted to the Macro-E tool that itself is connected to the internet (e.g., the Macro-E itself is enabled with a Certified Wireless USB system).

Changes to Macro-E settings may be recommended after assessing on one or more the following indicia of improvement in one or more skin attributes: (i) progress photographs uploaded, preferably at regular intervals in response to reminders, via the App; (ii) user self-assessments, preferably submitted with each progress photo upload; (iii) particle size information (changes over time as measured by light scattering and/or weight of tip assembly, or filters therein). In certain embodiments, progress may be evaluated by image analysis software using criteria established by a dermatologist or by a trained observer using criteria established by a dermatologist (e.g., licensed aesthetician, nurse, or physician).

Based on image analysis of a user's uploaded photographs and/or settings used on the Macro-E tool (e.g., as transmitted from the tool after each session) or data transmitted from the tool (amount of skin being exfoliated on a particular section of the body) portions of the user's skin may have indicia of being thick (cornified) or thin. Appropriate skin care products are recommended—topical OTC products containing chemical exfoliants (e.g., salicylic acid) or cosmetic scrubs containing abrasives (polyethylene beads) may be suggested for thicker areas and products containing retinol for thinner areas.

Based on the user's residence, notifications and recommendations are made to change Macro-E settings and/or to change skin care products associated with the user's profile. By way of non-limiting example, if the user profile indicates that she/he resides in an area that is expected to have an extended period freezing temperatures and high winds, the user would likely experience drier skin. A notification would be sent to change the Macro-E setting to increase exfoliation levels. The notification may be an alert or notification displayed on the user's mobile telecommunications device and/or sent to that device as a SMS message.

In a preferred embodiment of this aspect of the invention, geo-positioning is enabled in the App, allowing the App to identify the user's location. The App would thereby recognize that the user is/not in her/his area of primary residence and could send notifications/recommendations to the user based on changes in location. If, for example, the user is on winter vacation in a tropical climate with increased moisture content, decreased exfoliation might be recommended and a notification sent as an alert on the user's telecommunications device, via SMS to that device, or both.

As a further non-limiting example, in December, a message (email, SMS) or notification may be sent to the user's telecommunications device on which the App has been downloaded and installed, wishing the user a happy holiday season. The message may ask the user if she/he is planning to be away from her/his primary residence for holiday vacation, and if so where. If the user indicates that she/he will be in an area of high UV exposure (e.g., beach or skiing in the mountains), a follow-up message may be sent asking the user whether she/he has a sufficient amount of skincare products appropriate for that area, for example sunscreen, and prompting the user to order the products (sunscreen in this example) via an e-commerce shopping portal, which would then be shipped to the user before her/his planned vacation departure date.

In a method of marketing skincare products and cosmetic tools directly to consumers, including in a consumer products companies using a multi-level marketing model, skincare consultants interact directly with users who purchase the Macro-E device. In accordance with the methods of the present invention, a skincare consultant who sold a Macro-E tool to a specific user is provided, after receiving the user's permission (which can be given via the App), with access to one or more of the user's progress photographs, user submitted self-evaluation and/or data generated by the user's Macro-E tool. Based on this user specific information, the skincare consultant makes user specific recommendations including, for example, changes to the user's skincare product regimen, availability of new product offerings, including attachments for the Macro-E tool, which may complement and enhance the user's skincare results. In one embodiment, the cosmetic skincare tool and/or skincare products to be used in conjunction with the tool is/are offered for sale by a skincare consultant who is part of a multi-level marketing salesforce.

In a clinical study, the Macro-E tool was assessed for efficacy, tolerability and safety. Details of the study design and outcomes follow. 20 female subjects, 35 years or older, with lines, wrinkles, uneven skin texture, enlarged pores, and lack of firmness and no known medical conditions were selected to participate in a four-week study. A study protocol was submitted to and approved by an institutional review board. All subjects provided informed consent.

Subjects were supplied with a Macro-E tool as described above and skincare products as listed below, which were applied according to the indicated instructions.

Twice daily, morning and evening, subjects washed their face and applied a toner. A quarter-sized amount of a cleansing mask was applied using wet fingertips, gently and evenly massaging the mask onto dry skin, covering the skin with a thin coat, while avoiding contact with eyes. The mask was allowed to dry completely, for about 2-3 minutes. Thereafter, the skin was rinsed thoroughly and pat dry. Following cleansing, a toner was applied to the face with a gauze pad, avoiding the eye area. The toner was allowed to dry and was not rinsed off. In the morning, a dime-sized amount of an SPF 30 day cream was applied. A serum capsule was applied in the evening, followed by a dime-sized amount of a night cream. Subjects used the Macro-E tool once per week. Following use of the tool, subjects applied a dime-sized amount of a cooling hydrogel to the exfoliated skin.

The primary efficacy endpoint was the ability of the Macro-E tool in combination with complementary skincare products (described below) to improve the investigator assessed overall facial skin appearance as compared to baseline. At baseline, after a visit after one week, two weeks, and four weeks, the investigator assessed the following parameters: lines, wrinkles, skin texture, firmness/elasticity, pore size, even skin tone, and overall appearance. Subjects also self-assessed the following parameters at each visit: smoothness, softness, visible pores, wrinkles, radiance, even skin tone. High quality jpeg images of the front, right, and left face were taken at baseline, week 2, and week 4. In addition to clinical photography, the following non-invasive assessments of skin condition were performed: transepidermal water loss (TEWL) at baseline, week 2, and week 4; corneometry at week 4; skin elasticity at baseline and week 4; and Siflo replicas at baseline and week 4.

The tolerability endpoint was the investigator-assessed absence of skin irritation from the Macro-E tool in combination with complementary skincare products. The safety endpoint was the overall incidence of all adverse events reported during the study.

Users were instructed that the skin to be exfoliated (face, neck and décolleté) should be clean and dry prior to using the Macro-E tool. Users were instructed to select the DocSmart mode, with pre-programmed levels/times of exfoliation as set out in Table I above. If the user desired less or more exfoliation than the DocSmart mode, she was instructed to adjust the level (intensity of vacuum) by pressing the Up Arrow or Down Arrow. The selected level and body section being exfoliated was displayed on the LCD screen. After using the Macro-E tool, some users observed that the exfoliated skin appeared temporarily red and/or warm. This was transitory and not considered an adverse event. Study results—assessment by the principal investigator, a board certified dermatologist, or by the subject herself—are summarized below.

The investigator assessed the efficacy of the Macro-E tool and associated skin care regimen longitudinally (i.e., as the subjects used the tool and followed the skin care regimen). After one week of use, there was a highly statistically significant improvement in skin texture (p<0.001) and a statistically significant improvement in overall appearance (p=0.05). This improvement continued into week 2 where improvement in texture and overall appearance were highly statistically significant (p<0.001) and a statistically significant improvement in evenness was also noted (p=0.033). At the conclusion of the study in week 4, there were statistically significant improvements in reduction in appearance of both fine lines (p=0.026) and pores (p=0.029). In addition, there was highly statistically significant improvement in texture, evenness, and overall appearance (p<0.001). These results indicate significant effectiveness of the cosmetic macro-exfoliation tool when combined with the skin care products.

Improvements in skin parameters were also noted in subject self-assessments. At week 2, subjects reported improvement in smoothness (p=0.026), softness (p=0.007), radiance (p=0.048), evenness (p=0.013), pores (p=0.025), fine lines (p=0.012), age spots (p=0.029), and dryness (p<0.001). The subjects noted no statistically significant increase in irritation. Improvement continued into week 4 with similar, highly significant improvements in skin parameters as noted at week 2. Again no irritation issues were noted. Additionally, in response to a written questionnaire, subjects reported improvement in brightening, and texture.

Corneometry provides an instrumental assessment of the amount of water in the skin. In the four-week study, corneometry measurements increased from baseline (356.10) at week 2 (389.58) and week 4 (409.16), indicating statistically significant better skin hydration.

Skin elasticity (the force needed to pull the skin) also increased from baseline (21.73) to week 4 (25.17). This highly statistically significant result was consistent with the corneometry findings discussed immediately above and is indicative of improvements in skin firmness. Dermatologists and skin biologists consider skin elasticity to be directly related to better skin moisturization. The more water that is in the skin, the stronger the force required to deform the skin.

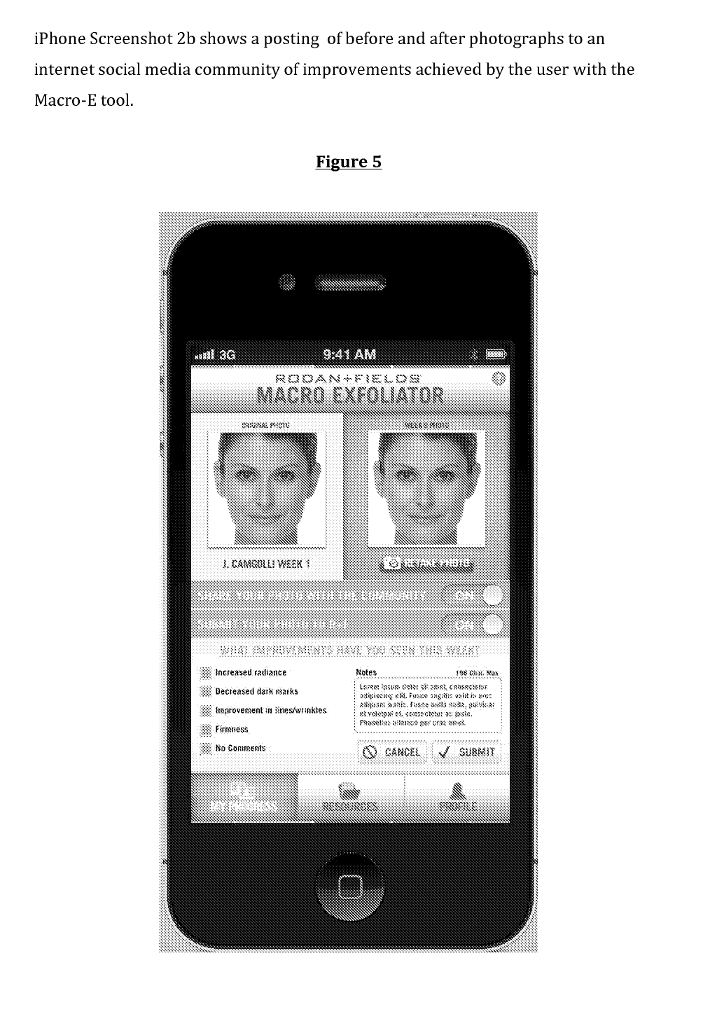

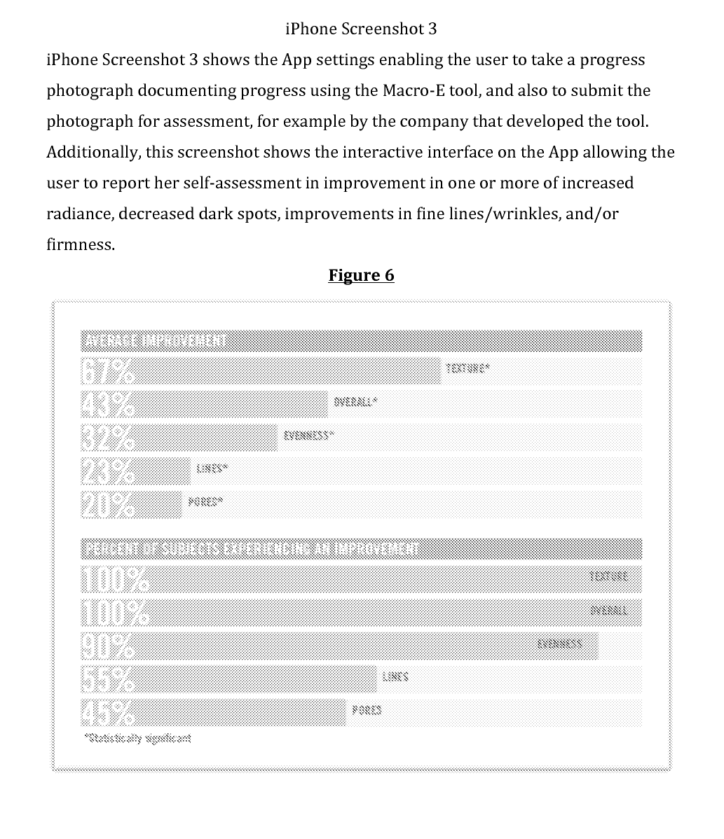

The above results are represented graphically in FIG. 6.

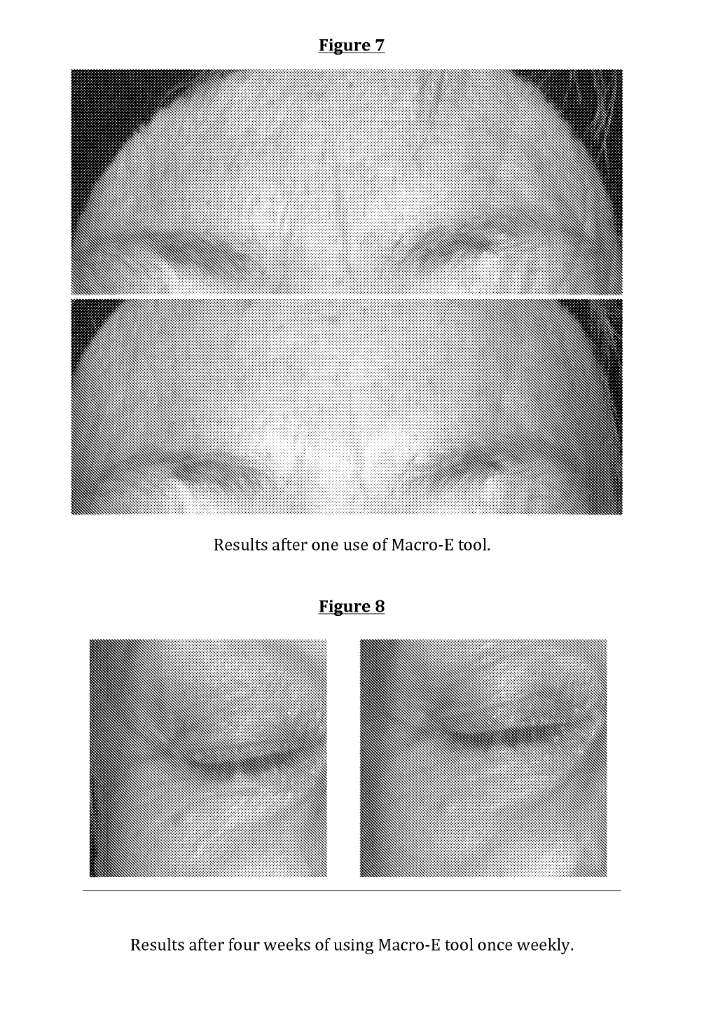

FIGS. 7 and 8 are representative clinical photos from the study showing improvement using the Macro-E tool.

1. A method of improving the appearance of at least one skin parameter by employing an at-home skincare system, comprising the steps of
a. providing a user in need of improving the appearance of one or more skin parameters with an electromechanical cosmetic skincare tool, said tool having a unique identifier;
b. the user downloading a mobile App, a software application designed to run on smartphone, a tablet computer, or other mobile telecommunication device;
c. querying the user and inputting information identifying the user and her/his skin condition and the user's cosmetic skincare tool;
d. transmitting and receiving data about or recorded/collected via the cosmetic skincare tool either via the App, directly from the tool, or both;
e. recommending changes to the user's skincare regimen and/or the manner in which the user's cosmetic skincare tool is used; and
wherein one or more of the skin parameters in need of improvement is selected from the group consisting of (i) number, size and appearance of fine lines and wrinkles, (ii) skin texture, (iii) skin firmness/elasticity, (iv) number of visible pores (v) evenness of skin tone, and (vi) skin radiance/brightness.

2. The method of claim 1, wherein the cosmetic skincare tool has wireless connectivity.

3. The method of claim 1, wherein querying the user and inputting information identifying the user and the user's cosmetic skincare tool is via an App.

4. The method of claim 1, wherein messages are sent via the App recommending changes to the user's skincare regimen and/or the manner in which the user's cosmetic skincare tool is used.

5. The method of claim 4, wherein the user transmits information regarding improvements in one or more of the user's skin parameters via the App.

6. The method of claim 4, wherein the user creates a photographic progress archive in the App, by the further steps of (i) saving a baseline image of the user's face in the App prior to using the cosmetic skincare tool and (ii) saving one or more images of the user's face in the App after using the cosmetic skincare tool.

7. The method of claim 6, wherein one or more image (s) saved in the photographic progress archive is/are photograph(s) taken by the user on a smart phone, tablet computer or other mobile telecommunications device on which the App has been downloaded and installed.

8. The method of claim 1, wherein the user enters her/his self-assessment of changes in her/his skin appearance based on at least one, preferably two, still more preferably three, and most preferably all four of (i) radiance, (ii) dark marks, (iii) lines/wrinkles, and/or (iv) firmness.

9. The method of claim 1 wherein, a cosmetic skincare tool having wireless connectivity stores and transmits information about or collected/recorded during or after a session in which the cosmetic skincare tool has been used.

10. The method of claim 9 wherein changes to settings of the cosmetic skincare tool are transmitted to, received by, and stored in a microprocessor control unit on the cosmetic skincare tool.

11. The method of claim 9, wherein based on the information transmitted to, received by, and stored in a microprocessor control unit on the cosmetic skincare tool, recommendations for changes to the user's skincare regimen and/or use of the cosmetic skincare tool are provided to the user via the App.

12. The method of claim 1, wherein the user is queried about one or more of the user's address, age, gender, residence location, skincare products used, and skin care concerns.

13. The method of claim 12, wherein the user is further queried about one or more lifestyle factors selected from the group consisting of (a) whether the user smokes and if the user has smoked the frequency and amount of cigarettes smoked, (b) the amount of time the user typically spends outdoors, (c) the frequency of use of sunscreen and/or sunglasses, (d) whether the user sleeps on her/his side, back, stomach, (e) the user's average number of hours of sleep per night, (f) and the relative frequency with which the user consumes beverages with a straw.

14. The method of claim 6, wherein the images in the user's photographic progress archive are evaluated by a skincare professional or image analysis software and recommendations for changes to the user's skincare regimen and/or use of the cosmetic skincare tool are provided to the user via the App.

15. The method of claim 1, wherein the user (i) creates a photographic progress archive in the App (ii) enters her/his self-assessment of changes in her/his skin appearance before and after using the cosmetic skincare tool, and/or (iii) transmits information about or collected/recorded during or after one or more sessions in which the cosmetic skincare tool has been used, and based on (i), (ii) and/or (iii) the user receives recommendations for changes to the user's skincare regimen and/or use of the cosmetic skincare tool are provided to the user via the App.

16. The method of claim 1, wherein the cosmetic skincare tool is a handheld macroexfoliation tool having (i) a removable exfoliation tip, comprised of an abrasive tip, a gasket and a filter, (ii) a vacuum pump, (iii) a motor, (iv) a microcontroller containing a processor core, memory and programmable input/output peripherals, (v) a user control panel comprising a plurality buttons and/or switches, (vi) a battery and battery charger and (vii) a display panel.

17. The method of claim 16, wherein the display panel indicates (i) a body section undergoing macro-exfoliation, (ii) a level/intensity of macro-exfoliation, (iii) a duration of macro-exfoliation on a body section, and (iv) remaining battery charge.

18. The method of claim 17, wherein the body section is selected the group consisting of forehead, periorbital (under-eye) areas, cheeks, nose, chin, neck and chest.

19. The method of claim 1, where one or more recommendations is/are made by a skincare consultant.

20. The method of claim 19, where the skincare consultant sells skincare products and/or cosmetic skincare tools directly to consumers.
